(19) United States
(12) Patent Application Publication
(10) Pub. No.: US 2014/0354099 A1
(43) Pub. Date: Dec. 4, 2014

(54) MAGNETIC MOTOR

(71) Applicant: Ramon FREIXAS VILA, Sarral (ES)

(72) Inventor: Ramon FREIXAS VILA, Sarral (ES)

(73) Assignee: RAMON FREIXAS VILA

(21) Appl. No.: 14/460,183

(22) Filed: Aug. 14, 2014

Related U.S. Application Data
(63) Continuation of application No. 14/012,266, filed on Aug. 28, 2013, now abandoned.
Application No. 14/012,266 is a continuation of application No. 12/202,449, filed on Sep. 2, 2008, now abandoned.
Application No. 12/202,449 is a continuation-in-part of application No. PCT/ES2007/000181, filed on Mar. 30, 2007.

(30) Foreign Application Priority Data
Apr. 4, 2006 (ES) P200600872

(51) Int. Cl. H02K 1/17; H02K 1/27

(52) U.S. Cl. CPC H02K 1/17; H02K 1/27
USPC 310/154.01

(57) ABSTRACT

A magnetic motor includes a rotor and a stator, in which there are magnets and materials of high magnetic permeability. The stator magnets are arranged with surfaces facing the rotor magnets in a staggered arrangement. The motor may be used to boost torque, for example in bicycles.

This is a Continuation of application Ser. No. 14/012,266 filed Aug. 28, 2013, which is a Continuation of application Ser. No. 12/202,449 filed Sep. 2, 2008, which is a Continuation in Part of Application No. PCT/ES2007/000181 filed Mar. 30, 2007. The disclosure of the prior application is hereby incorporated by reference herein in its entirety.

### BACKGROUND

The present invention concerns the technical area of magnetic motors.

There are motors with permanent magnets in the rotor and in the stator that maintain rotation only using the magnetic force of the magnets.

The magnets are attracted to each other to create a rotation; first the rotor magnets and the stator magnets have to be attracted, then this attraction has to diminish so that the rotor can separate from the stator. Japanese Patent Document JP 56110483 in FIG. 7 shows the attraction between the magnetic pole of the rotor and the magnetic pole of the stator, but the problem lies in the fact that the rotor magnet cannot escape from the attraction of the magnetic pole from the stator.

### SUMMARY

Embodiments of the present invention address the above mentioned problem. In embodiments, the two magnetic poles of the stator magnet face towards the rotor, thus the rotor magnet can escape from the attraction of the stator.

The motor includes a stator and a rotor where magnets maintaining rotation are located. Magnetic attraction occurs between the magnets of the rotor and the stator.

### BRIEF DESCRIPTION OF THE FIGURES

FIG. 1 shows a stator that includes magnets (1) and high magnetic permeability material (2); the material (2) is situated at the end in which the magnets (1) are closest to the rotor. The high magnetic permeability material (2) is near a face of the rotor magnet (3) with only one pole, which first approaches the stator. The elements comprising the rotor rotate in planes parallel to the stator axis (5A), as shown by broken lines.

FIG. 2 shows elements of the rotor rotating in planes parallel to the stator axis (5A).

### DETAILED DESCRIPTION OF EMBODIMENTS

The rotor:

The rotor is comprised of magnets (3) and a material (2b) that orientates the magnetic field, which can be a high magnetic permeability material.

The rotor magnets (3) are preferably disposed on arms (4) orthogonal to a shaft (5) that defines the axis of rotation of the rotor. The rotor magnets (3) rotate describing circles near the stator.

The rotor magnets have end faces (3a) with only one magnetic pole and side faces (3b) with two magnetic poles.

The rotor magnets may be arranged in different ways: the face (3b) with two magnetic poles facing the stator can be oblique or, if the face does not have inclination, the face (3b) may be parallel to the rotation plane of the rotor; the face (3b) can have a cut forming an angle in the end that is closest to the stator, with the two magnetic poles on the face parallel to the rotation plane, with a magnetic pole of the magnet which is the first to interact with the stator.

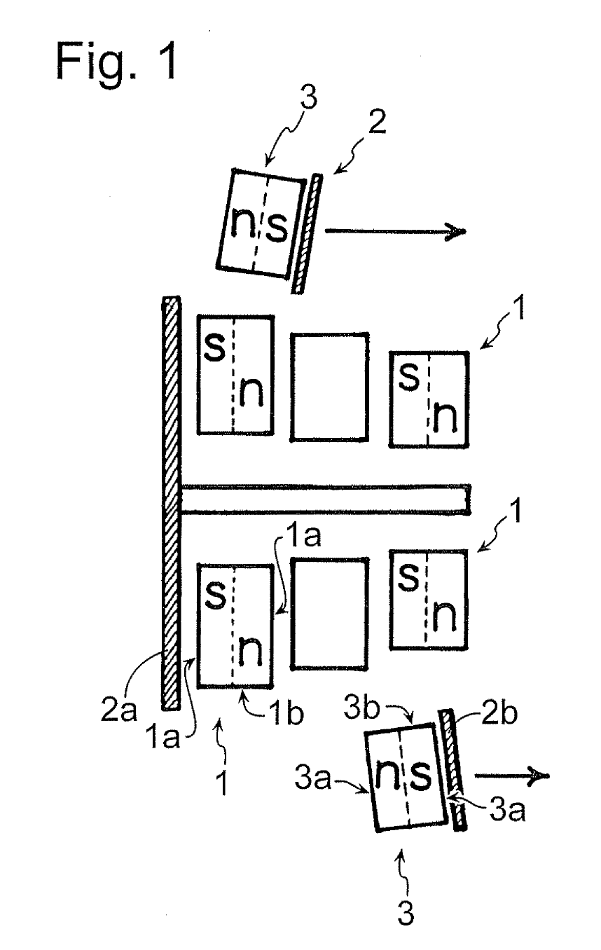

There is preferably a high magnetic permeability material next to a face (3a) of the rotor magnet. This material is preferably located next to the magnetic pole that, when approaching the stator, shows the same magnetic polarity as the stator end, usually close to the face of the first rotor pole that first interacts with the stator (FIG. 1).

The stator:

The stator is comprised of a group of magnets (1) and a material that orientates the magnetic field, which can be a high magnetic permeability material (2) located at one end of the stator.

The magnets (1) can be rectangular in cross section, and are attracted to one another on the faces (1a) that have only one magnetic pole; at least some of the faces that do not attract one another have two magnetic poles on their surface (1b) facing the rotor.

The magnets (1) that attract each other, which can be rectangular in cross section, are arranged in a staggered line, where the face with the two poles of each of the magnets (1) is increasingly further from the stator axis (5A) and increasingly closer to the rotor elements, up to a maximum limit or end magnet of the stator, which is the magnet closest to the rotor, next to which is the high magnetic permeability material (2a) (FIG. 1). The magnets are arranged in staggered lines on both sides in order to define an axis (5A) in the stator. The stator axis (5A) is a tangent of a circle situated on a plane orthogonal to the rotor axis, the center of the circle being a point of the rotor axis.

The two magnetic poles of the faces (1b) of the stator magnets facing the rotor, which are arranged in a staggered form, are situated on a face parallel to the stator axis (5A).

The rotation movement occurs when the rotor magnet approaches the stator and, once the interaction has taken place, the rotor magnet moves away from the stator. Depending on the inclination of the rotor magnet, the direction of rotation may be different. However, best rotation occurs when the rotor magnet has its face (3b) with the two magnetic poles parallel to the rotation plane; this face (3b) of the rotor which has the two magnetic poles parallel to the rotation plane can completely face each of the stator magnets. The faces with only one magnetic pole of the rotor magnet and the stator magnet always have the same magnetic polarity on the closest magnetic poles when the magnets are not completely facing each other (FIG. 1).

The first pole of the rotor magnet approaches the stator from the end of the stator that has the high magnetic permeability material (2a) and is attracted to the pole with opposite polarity of the magnet at the stator end, and then to the rest of the magnets with less power; this is why the face with the two magnetic poles of the stator should preferably be parallel to the stator axis, since if it is oblique, the pole with opposite polarity of the stator is lower and does not have much attraction power.

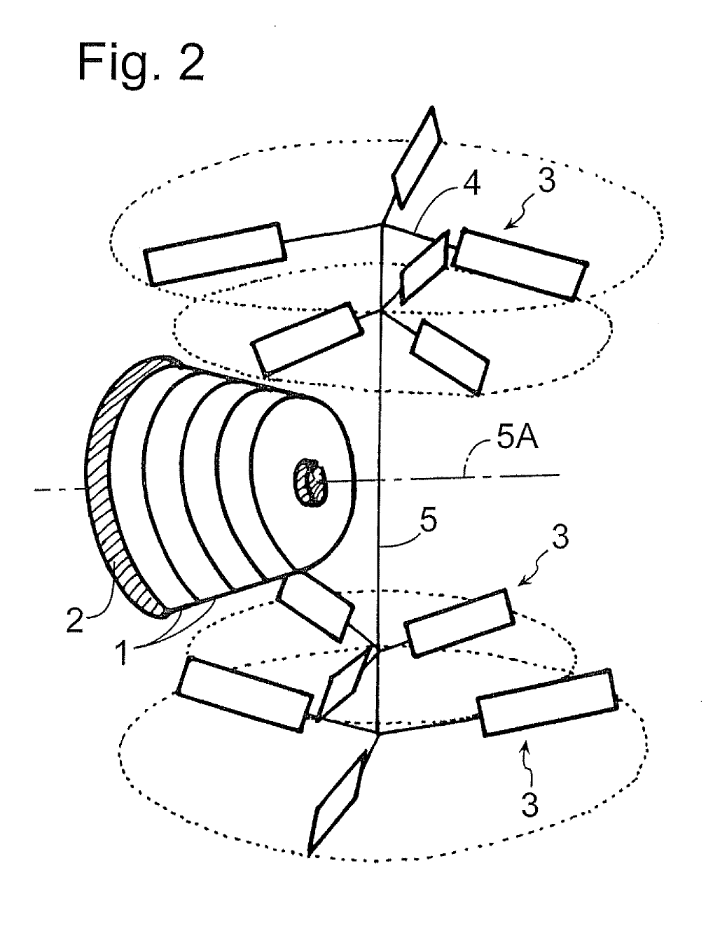

In order to create the motor, the elements that form the rotor are located on arms that rotate around the same shaft in planes parallel to the stator axis (5A), as shown in FIG. 2.

With reference to the figures, the depicted motor has a stator close to the rotor. In order to create the stator, magnets (1) that are rectangular in cross section are arranged to attract each other from the faces (1a) with the largest surface area with only one magnetic pole, separated by some distance, in a staggered form on both sides of the stator axis, to form a stack with the magnets (1) at the ends (1b) being at different distances from the rotor. The face of each magnet (1) that faces the rotor has the two magnetic poles on a face (1b) parallel to the stator axis (5A). The stator axis (5A) is a tangent of a circle orthogonal to the rotor axis (5).

The high magnetic permeability material (2a) is located at the stator end that has the magnet closest to the rotor, parallel to the face of the nearest stator magnet (1) with only one magnetic pole.

To create the rotor, magnets (3) and a high magnetic permeability material (2b) are used. The depicted magnets (3) are rectangular, with only one magnetic pole on the faces (3a) with the largest surface area; the faces facing the stator have two magnetic poles and are parallel to the rotation planes of the rotor magnets. The high magnetic permeability material (2b) is located in front of the face with only one magnetic pole that, when approaching the stator, has the same magnetic polarity as the stator end, and the high magnetic permeability material (2b) of the rotor is the first element of the rotor that comes close to the stator.

In rotation, the faces (3a) with only one magnetic pole of the rotor magnet (3) and the first stator magnet have the same magnetic polarity on the closest magnetic poles that approach when the magnets are not completely facing each other.

To create the motor, the elements of the rotor are situated on arms that rotate around the same shaft (5) in planes parallel to the stator axis (5A).

This is a device to help the rotation torque, which can be used, for example, in a bicycle pedal.

What is claimed is:

1. A magnetic motor, comprising:
a rotor comprising rotor magnets with faces having one magnetic pole and faces having two magnetic poles, said rotor having an axis of rotation, at least one first said rotor magnet having a rotor high magnetic permeability material next to a face of the first rotor magnet that has only one magnetic pole; and
a stator comprising stator magnets with faces having one magnetic pole and faces having two magnetic poles, said stator magnets attracting one another from said faces having only one magnetic pole, and a stator high magnetic permeability material at one end of said stator and parallel to a face with only one magnetic pole of the stator magnet, said stator having an axis, the stator axis being a tangent of a circle orthogonal to the rotor axis;
said first rotor magnet being configured such that, when said first rotor magnet approaches said end of the stator, said face of the first rotor magnet that has only one magnetic pole has the same magnetic polarity as a magnetic polarity of said end of the stator, and such that a face of the rotor magnet with two magnetic poles faces the stator;
the stator magnets forming a staggered structure in relation to the stator axis, faces of said stator magnets with two magnetic poles facing the rotor on a staggered line which is increasingly further from the stator axis and increasingly closer to the rotor, up to a stator magnet at the end of the stator at which the stator high magnetic permeability material is located.

2. The magnetic motor according to claim 1, wherein faces of the stator magnets having two magnetic poles and facing the rotor are parallel to the stator axis.

3. The magnetic motor according to claim 1, wherein the faces with only one magnetic pole of the rotor magnet and the stator magnet have the same magnetic polarity on the closest such faces when the faces of the rotor and stator magnets having two magnetic poles are not completely facing each other.

4. The magnetic motor according to claim 1, the motor being configured such that each magnet face has a midpoint, and the face of the first rotor magnet and the face of the stator magnet whose midpoints most closely approach one another during rotation of the rotor are both faces having two magnetic poles.
